(19) United States
(12) Patent Application Publication
(10) Pub. No.: US 2026/0072174 A1
(43) Pub. Date: Mar. 12, 2026

(54) INFORMATION PROCESSING DEVICE AND INFORMATION PROCESSING METHOD

(71) Applicant: Sony Semiconductor Solutions Corporation, Kanagawa (JP)

(72) Inventors: Jose Manuel GIL-CACHO, Basingstoke (GB); Jernej PERHAVC, Basingstoke (GB); Victor BELOKONSKIY, Basingstoke (GB)

(73) Assignee: Sony Semiconductor Solutions Corporation, Kanagawa (JP)

(21) Appl. No.: 19/108,751

(22) PCT Filed: Sep. 7, 2023
(86) PCT No.: PCT/EP2023/074531

§ 371 Date: Mar. 5, 2025

(30) Foreign Application Priority Data
Sep. 14, 2022 (EP) 22195669.1

(51) Int. Cl. G01S 17/894; G01S 7/4914; G01S 7/497

(52) U.S. Cl. CPC G01S 17/894; G01S 7/4914; G01S 7/497

(57) ABSTRACT

An information processing device for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, the information processing device comprising circuitry configured to: obtain first and second spot time-of-flight data acquired using a first and second measurement configuration of the spot time-of-flight device, respectively, wherein the first measurement configuration differs from the second measurement configuration; detect first spots associated with first pixel positions in the first spot time-of-flight data; detect second spots associated with second pixel positions in the second spot time-of-flight data; and determine spot pairs between the first spots and the second spots, wherein the spot pairs are determined based on the first and second pixel positions.

### TECHNICAL FIELD

The present disclosure generally pertains to an information processing device and an information processing method.

### TECHNICAL BACKGROUND

Generally, time-of-flight (ToF) devices are known which are used for determining a distance to or a depth map of (objects in) a scene that is illuminated with light based on the round-trip time/phase of the emitted light reflected from the scene. Typically, time-of-flight devices include an illuminator (e.g., a laser diode array), optical parts (e.g., lenses), an image sensor (e.g., an array of current assisted photonic demodulator (CAPD) pixels) and a control. Direct and indirect time-of-flight devices are known.

Moreover, spot ToF devices are known which include a spot illuminator that illuminates a scene with spotted light, for example, with a light pattern of separated high-intensity and low-intensity illumination areas such as a pattern of light dots, and an image sensor that detects the spotted light reflected from the scene to acquire spot time-of-flight data indicative for distances to the scene.

However, as generally known, (indirect) time-of-flight devices may be constrained by two limitations, namely saturation and phase wrapping (also known as aliasing).

Although there exist techniques for acquiring and processing spot time-of-flight data, it is generally desirable to improve the existing techniques.

### SUMMARY

According to a first aspect the disclosure provides an information processing device for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, the information processing device comprising circuitry configured to:
obtain first and second spot time-of-flight data acquired using a first and second measurement configuration of the spot time-of-flight device, respectively, wherein the first measurement configuration differs from the second measurement configuration;
detect first spots associated with first pixel positions in the first spot time-of-flight data;
detect second spots associated with second pixel positions in the second spot time-of-flight data; and
determine spot pairs between the first spots and the second spots, wherein the spot pairs are determined based on the first and second pixel positions.

According to a second aspect the disclosure provides an information processing method for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, the information processing method comprising:
obtaining first and second spot time-of-flight data acquired using a first and second measurement configuration of the spot time-of-flight device, respectively, wherein the first measurement configuration differs from the second measurement configuration;
detecting first spots associated with first pixel positions in the first spot time-of-flight data;
detecting second spots associated with second pixel positions in the second spot time-of-flight data; and
determining spot pairs between the first spots and the second spots, wherein the spot pairs are determined based on the first and second pixel positions.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates in a block diagram embodiment of a spot indirect time-of-flight device;

FIG. 2 schematically illustrates an embodiment of spot detection;

FIG. 3 schematically illustrates in a block diagram an embodiment of an information processing method;

FIG. 4 schematically illustrates an embodiment of spot matching;

FIG. 5 schematically illustrates in a block diagram an embodiment of an information processing method;

FIG. 6 schematically illustrates in a flow diagram an embodiment of replacing saturated spots;

FIG. 7 schematically illustrates an embodiment of replacing saturated spots;

FIG. 8 schematically illustrates in a flow diagram an embodiment of an information processing method;

FIG. 9 schematically illustrates in a flow diagram an embodiment of an information processing method;

FIG. 10 schematically illustrates in a flow diagram an embodiment of an information processing method; and

FIG. 11 schematically illustrates in a flow diagram an embodiment of an information processing method.

### DETAILED DESCRIPTION OF EMBODIMENTS

Before a detailed description of the embodiments under reference of FIG. 3 is given, general explanations are made.

As mentioned in the outset, generally, time-of-flight (ToF) devices are known which are used for determining a distance to or a depth map of (objects in) a scene that is illuminated with light based on the round-trip time/phase of the emitted light reflected from the scene. Typically, time-of-flight devices include an illuminator (e.g., a laser diode array), optical parts (e.g., lenses), an image sensor (e.g., an array of current assisted photonic demodulator (CAPD) pixels) and a control.

As further mentioned in the outset, spot ToF devices are known which include a spot illuminator that illuminates a scene with spotted light, for example, with a light pattern of separated high-intensity and low-intensity illumination areas such as a pattern of light dots, and an image sensor that detects the spotted light reflected from the scene to acquire spot time-of-flight data indicative for distances to the scene. Spot iToF (indirect time-of-flight) devices, for example, are becoming more and more interesting both for power and computational reasons.

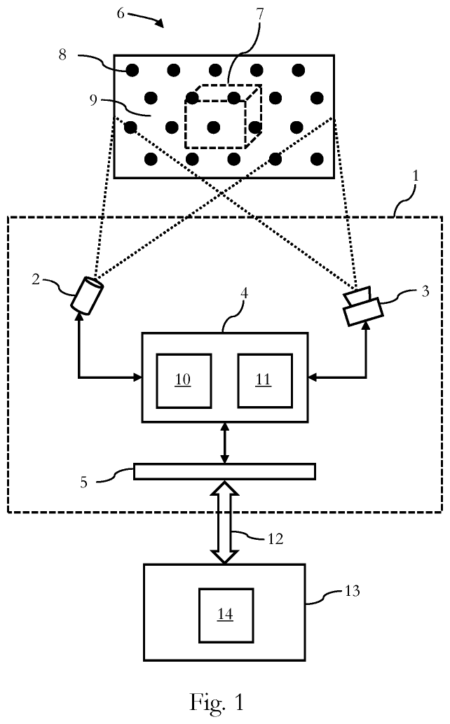

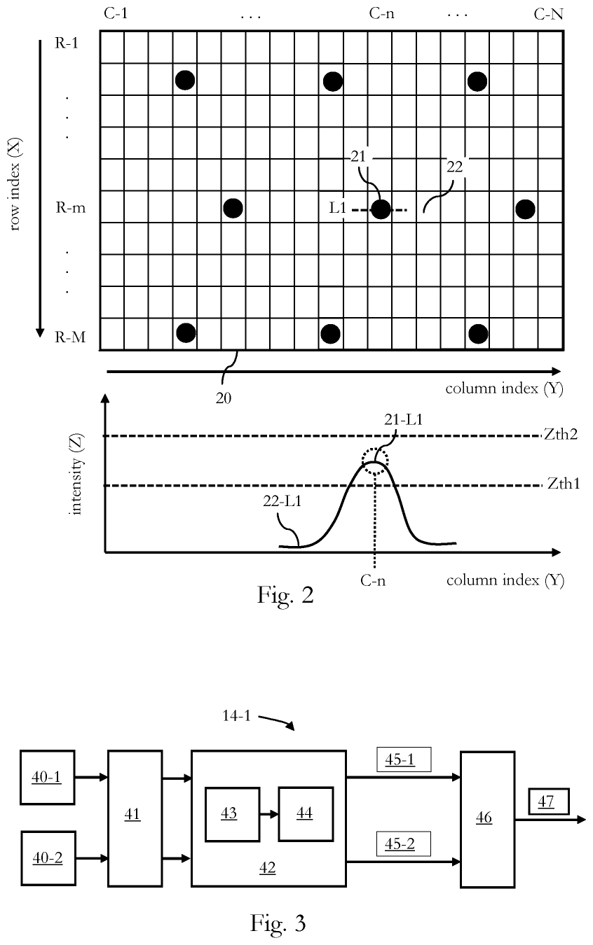

For enhancing the general understanding of the present disclosure, an embodiment of a spot indirect time-of-light device 1 (spot iToF device 1 in the following) is discussed under reference of FIGS. 1 and 2 in the following, which is also used in other embodiments of the present disclosure.

The FIG. 1 schematically illustrates in a block diagram the embodiment of the spot iToF device 1, which is discussed in the following.

The spot iToF system 1 includes a spot illuminator 2, a camera 3, a control 4 and a communication interface 5.

The spot illuminator 2 includes, e.g., a diode laser array as a light source or a laser and a diffractive optical element or the like to illuminate a scene 6 with spotted light. The scene 6 includes an object 7 which at least partially reflects the illumination light.

The spotted light has a spatial light pattern including high-intensity areas 8 and low-intensity areas 9 and, thus, a plurality of light spots corresponding to the high-intensity areas 8 is projected onto the scene 6. The light pattern or the light spots may be dots, stripes, or a checker pattern or the like.

Moreover, the spot illuminator 2 emits the spatially modulated light in an intensity modulated manner (in time) with a configured modulation frequency, in accordance with an applied modulation signal, to the scene 6. Typically, the applied modulation signal is a periodic signal such as a sinusoidal signal, a rectangular signal or the like.

As generally known, the unambiguous range of a distance measurement of an iToF system such as the spot iToF system 1 is given by:

$$range = \frac{c}{2 \cdot {f}_{mod}} = \frac{c \cdot {T}_{mod}}{2} ,$$

wherein c is the speed of light, f_{mod} is the modulation frequency (in time) of the illumination light and T_{mod} is the corresponding modulation period.

The camera 3 includes, e.g., a lens system, an aperture and an image sensor (not shown) to detect spotted light reflected from the scene 6 by the object 7.

For example, the image sensor includes a plurality of two-tapped current-assisted photonic demodulator (CAPD) pixels arranged in rows and columns. Each CAPD pixel generates, in accordance with an applied demodulation signal, an electric signal (e.g., voltage) in accordance with the phase of the reflected light signal. The demodulation signal is further phase-shifted by 180° between a first tap and a second tap of the two-tapped CAPD pixel and the difference of the electric signal of the two taps is output to decrease an ambient light contribution to the electric signal. Typically, the applied demodulation signal is a period signal such as a sinusoidal signal, a rectangular signal or the like in accordance with the modulation signal.

The integration time of the image sensor (of each two-tapped CAPD pixel) is controlled, for example, by controlling a number of modulation periods over which the electric signal is generated.

The control 4 executes software by a processor, for example, a control block 10 and a pre-processing block 11.

The control block 10 includes procedures having instructions to control the overall operation of the spot iToF device 1.

The control block 10 includes instructions to perform a ToF measurement to acquire spot ToF data, for example, the ToF measurement includes four correlation measurements, wherein for each correlation measurement a different phase shift between the modulation signal applied to the spot illuminator 2 and the demodulation signal applied to the image sensor is utilized (e.g., 0°, 90°, 180° and 270°).

Then, the pre-processing block 11 determines IQ values (I: in-phase component; Q: quadrature component) based on the electric signals generated in each correlation measurement (as generally known, the electric signals may undergo analog-to-digital conversion).

Then, the pre-processing block 11 determines, based on the IQ values, the phase of the reflected signal which is indicative for the distance to the scene 6, e.g., to the object 7.

Typically, in some embodiments, the plurality of light spots corresponding to the high-intensity areas 8 projected onto the scene 13 result in a corresponding light pattern on the image sensor. In other words, spots are present at some pixel positions (e.g., the pixel position indicates a certain pixel of the image sensor identified by its row and column index) and valleys are present between the spots.

As generally known, the spots may include signal contributions from the reflected light signal, ambient light and multi-path interference, wherein the valleys may include signal contributions from the ambient light and multi-path interference.

Hence, in some embodiments, the pre-processing block 11 decreases the multi-path interference contribution in the spots by subtracting the IQ values of a valley in the vicinity of a spot from the IQ values of the spot (which may also be referred to as global separation), thereby improving an accuracy of the distance measurement.

Moreover, the pre-processing block 11 determines, based on the (multi-path corrected) IQ values, amplitude and/or intensity and/or confidence (which are interrelated as generally known) which are indicative for a signal strength of the reflected light signal.

Then, the control 4 outputs the phase and/or distance (or depth) and the amplitude and/or intensity and/or confidence as spot ToF data to the communication interface 5 for transmission over a data bus 12 (e.g., a data bus in accordance with MIPI (Mobile Industry Processor Interface) specifications) to an information processing circuitry 13.

The information processing circuitry 13 is, e.g., an application processor which executes a spot ToF data processing block 14.

Generally, the spot ToF data processing block 14 may include the functions of the pre-processing block 11, e.g., when the control 4 outputs the electric signals (as generally known, the electric signals may undergo analog-to-digital conversion) of each correlation measurement.

The spot ToF data processing block 14 further includes procedures having instructions to detect spots in the spot ToF data.

FIG. 2 schematically illustrates an embodiment of spot detection, which is discussed in the following.

An image sensor 20 (e.g., of the camera 3 in FIG. 1) is schematically illustrated in FIG. 2, which has a plurality of two-tapped CAPD pixels arranged in rows (R-1, . . . , R-m, . . . , R-M; wherein M is an Integer) and columns (C-1, . . . , C-n, . . . , C-N; wherein N is an Integer). Each CAPD pixel has a pixel position identified by its row index (X) and its column index (Y).

As mentioned above, the spot ToF data processing block 14 obtains spot ToF data acquired by the spot iToF device 1 in a ToF measurement from the control 4.

The spot ToF data include a plurality of spots 21 and valleys 22 characterized by the amplitude/intensity/confidence values (Z) associated with each pixel position.

The lower graph in FIG. 2 schematically depicts intensity values along the line L1 parallel to the row R-m in the vicinity of the column C-n.

As illustrated there, a spot may spread over one or more pixels centered at column C-n—illustrated by reference number 21-L1—until the valley—illustrated by reference number 22-L1.

The spot ToF data processing block 14 detects the spot 21 based on a first predetermined intensity threshold Zth1. Furthermore, the spot ToF data processing block 14 detects whether the spot is saturated based on a second predetermined intensity threshold Zth2.

Once the spot is detected, the spot ToF data processing block 14 associates the spot 21 with a pixel position, for example, with X=R-m and Y=C-n. Each detected spot is further associated with a phase and/or distance value included in the obtained spot ToF data.

Generally, the spot ToF data acquired by the spot iToF device 1 in a ToF measurement may also be referred to as a frame or micro-frame.

Returning to the general explanations, as generally known, (indirect) time-of-flight devices may be constrained by two limitations, namely saturation and phase wrapping (also known as aliasing).

The phase wrapping (aliasing) limitation is due to a maximum phase that is unambiguously measured which is limited by the modulation frequency of the emitted light signal. The estimated distance is a function of the phase of the received light signal relative to the phase of the emitted light signal. In some embodiments, this is a periodical function because the emitted light signal is amplitude-modulated with a periodic function and, thus, different distances produce the same phase measurement, which is known as aliasing or phase wrapping.

Hence, it has been recognized that there is a need to disambiguate the spot iToF data. In some embodiments, to disambiguate phase measurements, a multi modulation frequency system is used (two or more data (micro-)frames acquired using different modulation frequencies), for example, where one low frequency modulated light signal (one data (micro-)frame) is used to disambiguate the range on another high frequency modulated light signal (second data (micro-)frame).

It has further been recognized that the saturation issue in spot iToF measurements should be tackled. As generally known, the minimum phase to be measured is limited typically by pixel over exposure (i.e., saturation of the pixel). In some image sensors, pixels have a saturation limit which typically depends on incident irradiance during exposure time (physical constraints limit the maximum irradiance that can be measured for a given camera setting). However, reducing an exposure time may increase the noise in far distances.

It has been recognized that, in iToF devices, a technique to increase the working range may include combining the signals of several data frames using different exposure times. For example, short time exposures will not saturate as close as long-time exposures.

In particular, it has been recognized that spot iToF devices may, in some cases, have valid information only in the vicinity of the spots (as discussed above, spot iToF data are sparse data, e.g., sparse phase/distance and/or sparse amplitude/intensity/confidence.

Hence, it has been recognized that for spot iToF devices which combine two or more data frames for phase unwrapping and/or dynamic range extension, the frames should be matched on a pixel-wise position of the spot.

It has been recognized that the pixel-wise spot position may be different from frame to frame because, for example, the spot position is estimated from noisy data or due to a parallax between the spot illuminator and the image sensor, e.g., when there is some motion (in the scene or ego-motion), the spot position may change from frame to frame.

It is generally known to use dual frequency to disambiguate phase measurements, for example, by doing the iToF measurement twice using two different modulation frequencies. Similarly for high dynamic range (HDR) systems it is known to combine an extra data frame at lower exposure time to be combined with the data frame at higher exposure time.

However, as mentioned above, valid information in spot iToF measurements for dealiasing and/or saturation extension may only be obtained in the second frame for spots in the vicinity of the spot of the first frame.

Hence, it has been recognized that for applying the phase unwrapping and/or dynamic range extension to spot iToF devices a pixel-wise spot matching should be implemented, since it has been recognized that—without spot matching—multiple subsequent frames may, in some cases, fail to give an accurate dealiased phase/distance measurement and/or accurate HDR output.

Thus, in some embodiments, a pixel-wise spot matching is used for dual frequency phase unwrapping and high dynamic range extension mode for saturation range extension.

Hence, some embodiments pertain to an information processing device for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, wherein the information processing device includes circuitry configured to:
obtain first and second spot time-of-flight data acquired using a first and second measurement configuration of the spot time-of-flight device, respectively, wherein the first measurement configuration differs from the second measurement configuration;
detect first spots associated with first pixel positions in the first spot time-of-flight data;
detect second spots associated with second pixel positions in the second spot time-of-flight data; and
determine spot pairs between the first spots and the second spots, wherein the spot pairs are determined based on the first and second pixel positions.

In some embodiments, the information processing device includes the spot time-of-flight device. in some embodiments, the spot time-of-flight device includes the information processing device. In some embodiments, the information processing device and the spot-time-of-flight device are separated devices.

In some embodiments, the information processing device is a data processing module, a computer, a smartphone, a virtual reality device or the like.

In some embodiments, the spot time-of-flight device is a spot indirect time-of-flight device.

The spot illuminator may include a light emitting diode (LED), a laser, a laser diode, an LED array, a laser diode array, a diffractive optical element, a lens system, etc.

The image sensor (it may also be referred to as time-of-flight image sensor) may be a CAPD pixel array including a plurality of CAPD pixels arranged in rows and columns, a single photon avalanche diode (SPAD) array including a plurality of SPAD pixels arranged in rows and columns, a charge-coupled device (CCD), an active-pixel sensor or the like.

The circuitry may be based on or may include or may be implemented as integrated circuitry logic or may be implemented by a CPU (central processing unit), an application processor, a graphical 15 processing unit (GPU), a microcontroller, an FPGA (field programmable gate array), an ASIC (application specific integrated circuit) or the like or a combination thereof.

The functionality may be implemented by software executed by a processor such as a microprocessor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include data storage capabilities to store data such as memory which may be based on semiconductor storage technology (e.g., RAM, EPROM, etc.) or magnetic storage technology (e.g., a hard disk drive) or the like.

The circuitry may include a data bus for receiving and transmitting data over the data bus. The circuitry may implement communication protocols for receiving and transmitting the data over the data bus.

The circuitry is configured to determine spot pairs between the first spots and the second spots, wherein the spot pairs are determined based on the first and second pixel positions.

In some embodiments, the spot pairs between the first spots and the second spots are determined for dealiasing and/or dynamic range extension. Other use cases may include, for example, motion calculation related use cases.

In some embodiments, the circuitry determines the spot pairs based on an amount of the spot movement and/or direction of the spot movement between the first and the second time-of-flight measurement (performed with the first and second measurement configuration, respectively) indicated by differences between the first and second pixel positions.

In some embodiments, the first time-of-flight measurement corresponds to a reference time-of-flight measurement.

In some embodiments, the circuitry is configured to determine a spot pair by determining whether a second pixel position at which a second spot of the second spots is detected is within a predetermined range around a first pixel position at which a first spot of the first spots is detected.

In other words, in some embodiments, the circuitry is configured to determine a first spot of the first spots and a second spot of the second spots to be a spot pair when a second pixel position at the second spot is detected is within a predetermined range around a first pixel position at which the first spot is detected.

In some embodiments, the predetermined range corresponds to a pixel index window centered at the first pixel position.

In some embodiments, the size of the pixel index window varies depending on how many pixels the second spots are expected to move due to parallax (related to the distance between the image sensor and the illuminator) and motion. Hence, in some embodiments, the circuitry is configured to adapt, based on an expected amount of movement of the second spots, the size of the pixel index window.

As typically, in some embodiments, spot ToF data of subsequent frames are processed pixel-wise (data associated with a pixel position in the first frame is processed with data associated with the same pixel position in the second frame), the pixel positions in the spot time-of-flight data of the two time-of-flight measurements should match.

In some embodiments, the detection of the second spots and the spot pairing is performed at the same time. In such embodiments, all first spots are found in one first frame and the search of the second spots in the second frame is constrained to be within the search window.

Hence, in some embodiments, the circuitry is configured to detect second spots associated with second pixel positions in the second spot time-of-flight data, wherein a detection window is constrained to a plurality of pixel index windows, wherein each of the plurality of pixel index windows is centered at a first pixel position of the first pixel positions. In such embodiments, a second spot is paired with a first spot when it is detected within the respective pixel index window centered at the first pixel position associated with the first spot.

In other words, second spots for pairing are only searched within the detection window which corresponds to the plurality of pixel index windows around the first pixel positions associated with the first spots.

In some embodiments, the circuitry is configured to assign for each spot pair, in the second spot time-of-flight data, the first pixel position to the second spot.

It has further been recognized that it must be decided how non-paired spots (e.g., a second spot which is outside of the search window centered at the pixel position of the first spot) are handled. It has been recognized that selecting the first spots for non-paired spots may decrease consistency/accuracy of the dealiased and/or saturation extended spot time-of-flight data.

Hence, in some embodiments, the circuitry is configured to handle non-paired spots as invalid data.

However, in other embodiments, the circuitry is configured to handle non-paired spots by using the first spot or the second spot or a combination thereof.

As mentioned above, one use case is phase unwrapping (dealiasing).

Thus, in some embodiments, the first measurement configuration differs from the second measurement configuration in a modulation frequency of the spotted light. The modulation frequency refers to the modulation of the spotted light in time as a periodic signal (not the spatial modulation related to the light pattern with which the scene is illuminated).

In some embodiments, the first time-of-flight measurement corresponds to a reference time-of-flight measurement. Typically, for a same integration time of the image sensor, a lower modulation frequency allows acquiring the spot time-of-flight data with high confidence values (better demodulation contrast).

In some embodiments, a modulation frequency of the spotted light is lower in the first measurement configuration than in the second measurement configuration, and the circuitry is configured to perform, for each spot pair, dealiasing to generate dealiased spot time-of-flight data.

As mentioned above, a further use case is dynamic range extension (or saturation range extension).

Thus, in some embodiments the first measurement configuration differs from the second measurement configuration in an integration time of the image sensor.

In other embodiments, the first measurement configuration differs from the second measurement configuration in an optical power of the spotted light with which the scene is illuminated.

In some embodiments, the integration time of the image sensor is lower in the first measurement configuration than in the second measurement configuration, and the circuitry is configured to perform, for each spot pair, dynamic range extension to generate saturation extended spot time-of-flight data. For example, in some embodiments, for each spot pair, saturated second spots are replaced with unsaturated first spots (e.g., the distance value is replaced). This may allow to cover short and long distances in the scene with comparable accuracy.

It has been recognized that dealiasing (phase unwrapping) and dynamic range extension may be reached together by using three data frames.

Thus, in some embodiments, three data frames are used. Two data frames at high exposure time to improve the maximum distance limit (phase unwrapping), and a third data frame at low exposure time to improve the minimum distance limit (saturation). The sequential combination of these three spot data frames provides in some embodiments a system that breaks the limits which a single data frame system would face.

As mentioned above, in some embodiments, a modulation frequency of the spotted light is lower in the first measurement configuration than in the second measurement configuration, and the circuitry is configured to perform, for each spot pair, dealiasing to generate dealiased spot time-of-flight data.

In some embodiments, the circuitry is configured to detect saturated spots associated with saturation pixel positions in the dealiased spot time-of-flight data.

In some embodiments, the circuitry is configured to:
obtain third spot time-of-flight data acquired using a third measurement configuration of the spot time-of-flight device, wherein an integration time of the image sensor in the third measurement configuration is lower than in the first and second measurement configuration,
detect unsaturated third spots associated with third pixel positions in the third spot time-of-flight data, and
replace a saturated dot in the dealiased spot time-of-flight data with an unsaturated third spot when a third pixel position at which the unsaturated third spot is detected is within a predetermined range around a saturation pixel position at which the saturated dot is detected.

In some embodiments, the modulation frequencies in the second and third measurement configuration are equal, and wherein the integration times of the image sensor in the first and second measurement configuration are equal.

Some embodiments pertain to a (n) (corresponding) information processing method for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, wherein the information processing method includes:
obtaining first and second spot time-of-flight data acquired using a first and second measurement configuration of the spot time-of-flight device, respectively, wherein the first measurement configuration differs from the second measurement configuration;
detecting first spots associated with first pixel positions in the first spot time-of-flight data;
detecting second spots associated with second pixel positions in the second spot time-of-flight data; and
determining spot pairs between the first spots and the second, wherein the spot pairs are determined based on the first and second pixel positions.

The information processing method may be performed by the information processing device as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

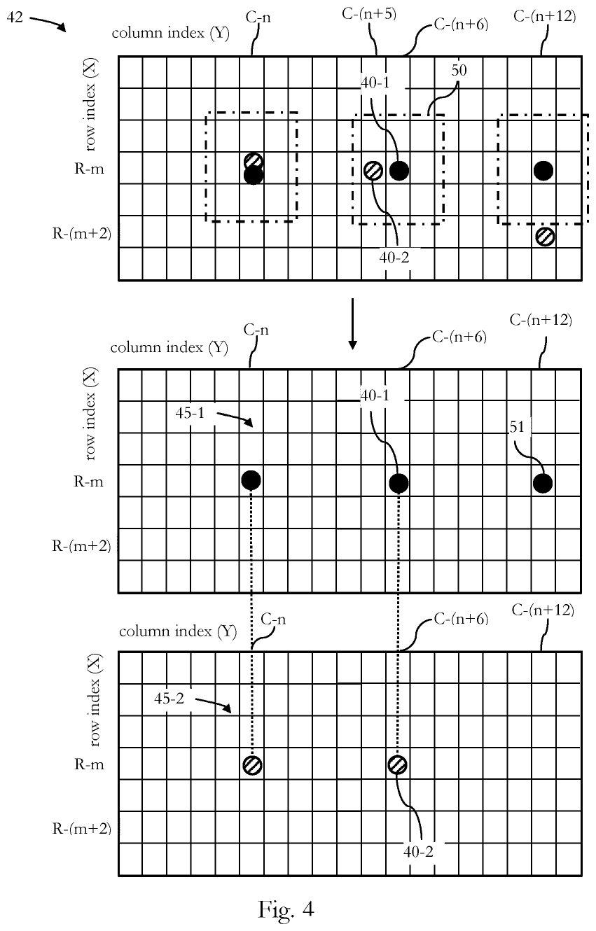

Returning to FIG. 3, which schematically illustrates in a block diagram an embodiment of an information processing method, which is discussed in the following under reference of FIG. 3 and FIG. 4.

The information processing method is carried out in the spot ToF data processing block 14-1 as an embodiment of the spot ToF data processing block 14 of FIG. 1.

The spot ToF data processing block 14-1 obtains first spot ToF data 40-1 acquired using a first measurement configuration of the spot iToF device 1.

The spot ToF data processing block 14-1 obtains second spot ToF data 40-2 acquired using a second measurement configuration of the spot iToF device 1.

In some embodiments, the first measurement configuration differs from the second measurement configuration in a modulation frequency of the spotted light with which the scene 6 is illuminated.

As mentioned above, for example, the modulation frequency of the spotted light is lower in the first measurement configuration than in the second measurement configuration.

In some embodiments, the first measurement configuration differs from the second measurement configuration in an integration time of the image sensor.

As mentioned above, for example, the integration time of the image sensor is lower in the first measurement configuration than in the second measurement configuration.

The spot ToF data processing block 14-1 includes a spot/spot saturation detection block 41 which detects first spots/second spots in the first spot ToF data 40-1/second spot ToF data 40-2 associated with first/second pixel positions and detects saturated spots among the first spots/second spots associated with saturation pixel positions, e.g., based on their intensity values as discussed under reference of FIG. 2 which schematically illustrates it in the lower graph.

The spot ToF data processing block 14-1 includes a spot matching block 42 which includes a spot pairing block 43 and a non-paired spot handle block 44.

The spot pairing block 43 determines spot pairs between the first spots and the second spots, wherein the spot pairs are determined based on the first and second pixel positions.

The non-paired spot handle block 44 handles non-paired spots as invalid data.

Referring now to FIG. 4, which schematically illustrates an embodiment of spot matching (spot matching block 42), which is discussed in the following.

The FIG. 4 depicts schematically in the upper area the image sensor 20 of FIG. 2 in which first spots (black dots) in the first spot ToF data 40-1 and second spots (cross-striped dots) in the second spot ToF data 40-2 are illustrated at their associated first and second pixel positions, respectively.

For illustration purposes only, first spots are detected at first pixel positions (R-m, C-n), (R-m, C-(n+6)) and (R-m, C-(n+12)) and second spots are detected at second pixel positions (R-m, C-n), (R-m, C-(n+5) and (R-(m+2), C-(n+12)).

Furthermore, a pixel index window 50 is schematically illustrated for each first spot which is centered at the respective first pixel position, and which defines a predetermined range around the respective first spot, here for illustration purposes only, the predetermined range for the first spot at (R-m, C-n) is given by the index set (R-(m+1), C-(n+1)).

Hence, when a second spot is detected at a second pixel position which is in the index set, the second spot is paired with the corresponding first spot for dealiasing and/or dynamic range extension.

As depicted in FIG. 4, the left first and second spot have the same pixel position and the second spot is within the pixel index window 50, the middle second spot is shifted one pixel to the left in relation to the middle first spot but is still within pixel index window 50, however, the right second spot is shifted two pixels downwards in relation to the right first spot and is thus out of the pixel index window 50.

Hence, the spot pairing block 43 determines the left and middle first spots to be paired with the respective left and middle right spots. The right spots are determined to be non-paired.

Then, the spot pairing block 43 assigns for each spot pair, in the second spot ToF data 40-2, the first pixel position to the second spot.

In other words, the middle second spot is moved from (R-m, C-(n+5)) to (R-m, C-(n+6)) to match the spot positions in the two subsequent frames pixel-wise for dealiasing and/or dynamic range extension.

The non-paired spot handle block 44 adds, in the first spot ToF data, an invalid data label to the right first spot which is not used for dealiasing and/or dynamic range extension in subsequent processing.

Moreover, the non-paired spot handle block 44 removes, in the second spot ToF data 40-2, the right second spot which has no partner.

As illustrated in the middle area of FIG. 4, the spot matching block 42 outputs first spot paired ToF data 45-1 (indicated by the dotted lines) which include the first spots, wherein the right first spot is labeled as invalid data 51.

As illustrated in the lower area of FIG. 4, the spot matching block 42 further outputs second spot paired ToF data 45-2 which include the second spots, wherein the spot positions of the second spots are matched with the spot positions of the first spot, and wherein the non-paired second spot is removed.

Returning to FIG. 3, the first spot paired ToF data 45-1 and the second spot paired ToF data 45-2 is processed by dealiasing/dynamic range extension block 46.

The dealiasing/dynamic range extension block 46 performs for each spot pair dealiasing/dynamic range extension to generate dealiased/saturation extended spot ToF data 47.

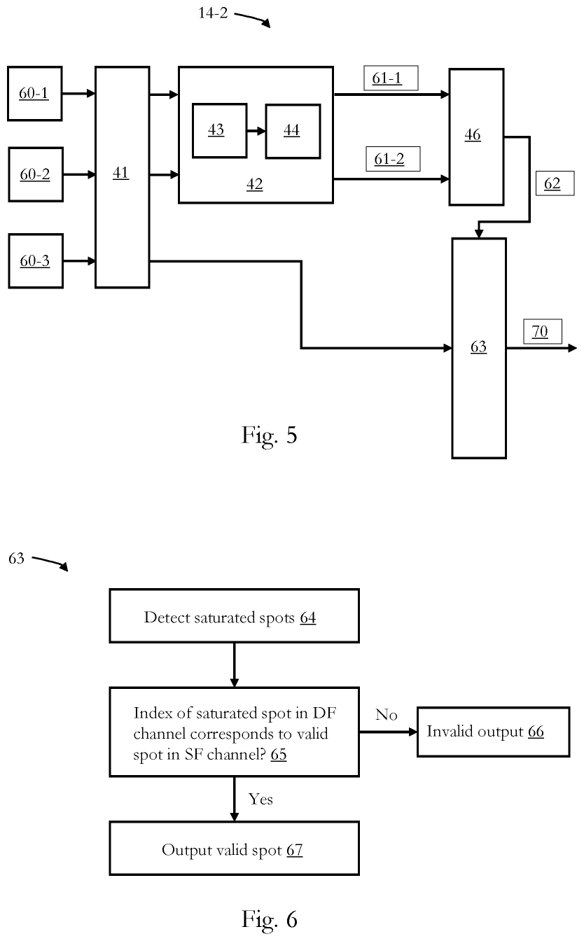

FIG. 5 schematically illustrates in a block diagram an embodiment of an information processing method, which is discussed in the following under reference of FIGS. 5, 6 and 7.

The information processing method is carried out in the spot ToF data processing block 14-2 as an embodiment of the spot ToF data processing block 14 of FIG. 1.

The spot ToF data processing block 14-2 obtains first spot ToF data 60-1 acquired using a first measurement configuration of the spot iToF device 1.

The spot ToF data processing block 14-2 obtains second spot ToF data 60-2 acquired using a second measurement configuration of the spot iToF device 1.

The first and second spot ToF data 60-1 and 60-2 correspond to spot ToF data of a dual frequency (DF) channel including two single frequency (SF) channels.

The spot ToF data processing block 14-2 obtains third spot ToF data 60-3 acquired using a third measurement configuration of the spot iToF device 1.

The third spot ToF data 60-3 corresponds to a single frequency (SF) channel.

In this embodiment, the first measurement configuration differs from the second measurement configuration in a modulation frequency of the spotted light with which the scene 6 is illuminated.

Moreover, an integration time of the image sensor in the third measurement configuration is lower than in the first and second measurement configuration.

Furthermore, the modulation frequencies in the second and third measurement configuration are equal, and the integration times of the image sensor in the first and second measurement configuration are equal.

The spot ToF data processing block 14-2 is tailored towards long range use cases, reaching further distances, recovering measurements also in low SNR (Signal-to-Noise Ratio) conditions (e.g., low reflectivity objects, long range) without aliasing and at the same time having a short effective range.

An example use case is for mobile phones (e.g., smartphone) including a depth sensing system, where typical working distances are long range, but short distance objects may appear in the field of view.

The DF channel uses high integration times in each SF channel and, thus, it may saturate at close distances. To overcome this limitation, the SF channel with lower integration time is added to have one channel where saturation may occur at even closer distances.

The spot ToF data processing block 14-2 includes the spot/spot saturation detection block 41 of FIG. 3 which detects first spots/second spots/third spots in the first spot ToF data 60-1/second spot ToF data 60-2/third spot ToF data 60-3 associated with first/second/third pixel positions and detects saturated spots among the first spots/second/third spots associated with saturation pixel positions, e.g., based on their intensity values as discussed under reference of FIG. 2 which schematically illustrates it in the lower graph.

The spot ToF data processing block 14-2 further includes the spot matching block 42 of FIG. 3 for the DF channel which includes the spot pairing block 43 and the non-paired spot handle block 44.

The spot matching block 42 performs the spot pairing/spot position matching and non-paired spot data handling as discussed under reference of FIGS. 3 and 4. To avoid unnecessary repetitions, it is referred to the discussion above.

The spot matching block 42 outputs first spot paired ToF data 61-1 and second spot paired ToF data 61-2.

The dealiasing block 46 performs for each spot pair dealiasing to generate dealiased spot ToF data 62.

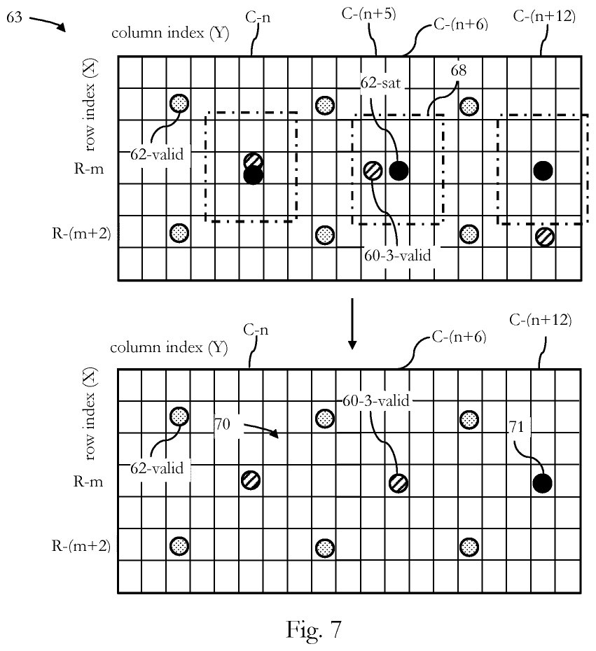

The spot ToF data processing block 14-2 further includes a dynamic range extension block 63 to generate dealiased saturation range extended spot ToF data 70, which is discussed in the following under reference of FIGS. 6 and 7, wherein FIG. 6 schematically illustrates in a flow diagram an embodiment of replacing saturated spots and FIG. 7 schematically illustrates an embodiment of replacing saturated spots.

The dynamic range extension block 63 detects, at 64, saturated spots and unsaturated spots (also referred to as valid spot) in the dealiased spot ToF data 62, e.g., based on the saturation detection already performed in the spot/spot saturation detection block 41 or based on their intensity values as discussed under reference of FIG. 2 which schematically illustrates it in the lower graph.

Moreover, the dynamic range extension block 63 detects, at 64, unsaturated spots (also referred to as valid spot) in the third spot ToF data 60-3, e.g., based on the saturation detection already performed in the spot/spot saturation detection block 41.

The dynamic range extension block 63 determines, at 65, whether an index of a saturated spot in the DF channel (in the dealiased spot ToF data 62) corresponds to a valid spot in the SF channel (in the third spot ToF data 60-3).

If no, at 66, the saturated spot is handled as invalid data.

If yes, at 67, the saturated spot in the dealiased spot ToF data 62 is replaced with the valid spot of the third spot ToF data 60-3.

This is schematically illustrated in FIG. 7, which is discussed in the following.

The FIG. 7 depicts schematically in the upper area the image sensor 20 of FIG. 2 in which valid dealiased spots 62-valid (dotted dots) are illustrated at their associated pixel positions and saturated dealiased spots 62-sat (black dots) in the dealiased spot ToF data 62 are illustrated at their associated saturation pixel positions. Moreover, valid spots 60-3-valid (striped dots) are illustrated at their respective third pixel positions.

For illustration purposes only, saturated spots 62-sat are detected at saturation pixel positions (R-m, C-n), (R-m, C-(n+6)) and (R-m, C-(n+12)) and valid spots 60-3-valid are detected at third pixel positions (R-m, C-n), (R-m, C-(n+5)) and (R-(m+2), C-(n+12).

Furthermore, a pixel index window 68 is schematically illustrated for each saturated spot which is centered at the respective saturation pixel position, and which defines a predetermined range around the respective saturated spot, here for illustration purposes only, the predetermined range for the saturated spot at (R-m, C-n) is given by the index set (R-(m+1), C-(n+1)).

Hence, when a valid spot 60-3-valid is detected at a third pixel position which is in the index set, the saturated spot 62-sat is replaced with the valid spot 60-3-valid.

As depicted in FIG. 7, the left saturated spot 62-sat and the left valid spot 60-3-valid have the same pixel position and the left valid spot 60-3-valid is within the pixel index window 68. The middle saturated spot 62-sat and the middle valid spot 60-3-valid are shifted one pixel relation to each other but the middle valid spot 60-3-valid is still within the pixel index window 68. The right saturated spot 62-sat and the right valid spot 60-3-valid are shifted two pixels in relation to each other and the right valid spot 60-3-valid is thus out of the pixel index window 68.

Hence, the dynamic range extension block 63 determines the left and middle saturated spots 62-sat to be replaced with the respective left and middle valid spots 60-3-valid. The right saturated spot is determined to be invalid data 71 and is labeled accordingly.

Thus, as illustrated in the lower area of FIG. 7, the dealiased saturation range extended spot ToF data 70 include the valid dealiased spots 62-valid, the left and middle valid spots 60-3-valid and the labeled invalid data 71.

Consequently, the spot ToF data processing block 14-2 is tailored towards long range use cases, reaching further distances, recovering measurements also in low SNR (Signal-to-Noise Ratio) conditions (e.g., low reflectivity objects, long range) without aliasing and at the same time having a short effective range.

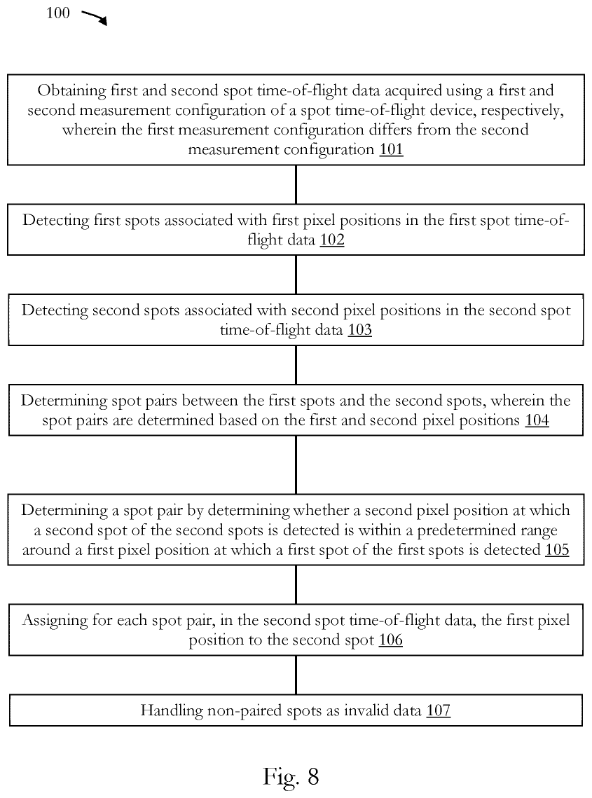

FIG. 8 schematically illustrates in a flow diagram an embodiment of an information processing method 100, which is discussed in the following.

The information processing method 100 may be performed by an information processing device as described herein.

At 101, first and second spot time-of-flight data acquired using a first and second measurement configuration of a spot time-of-flight device are obtained, respectively, wherein the first measurement configuration differs from the second measurement configuration, as discussed herein.

At 102, first spots associated with first pixel positions in the first spot time-of-flight data are detected, as discussed herein.

At 103, second spots associated with second pixel positions in the second spot time-of-flight data are detected, as discussed herein.

At 104, spot pairs between the first spots and the second spots are determined, for example, for dealiasing and/or dynamic range extension, wherein the spot pairs are determined based on the first and second pixel positions, as discussed herein.

At 105, a spot pair is determined by determining whether a second pixel position at which a second spot of the second spots is detected is within a predetermined range around a first pixel position at which a first spot of the first spots is detected, as discussed herein.

At 106, for each spot pair, in the second spot time-of-flight data, the first pixel position is assigned to the second spot, as discussed herein.

At 107, non-paired spots are handled as invalid data, as discussed herein.

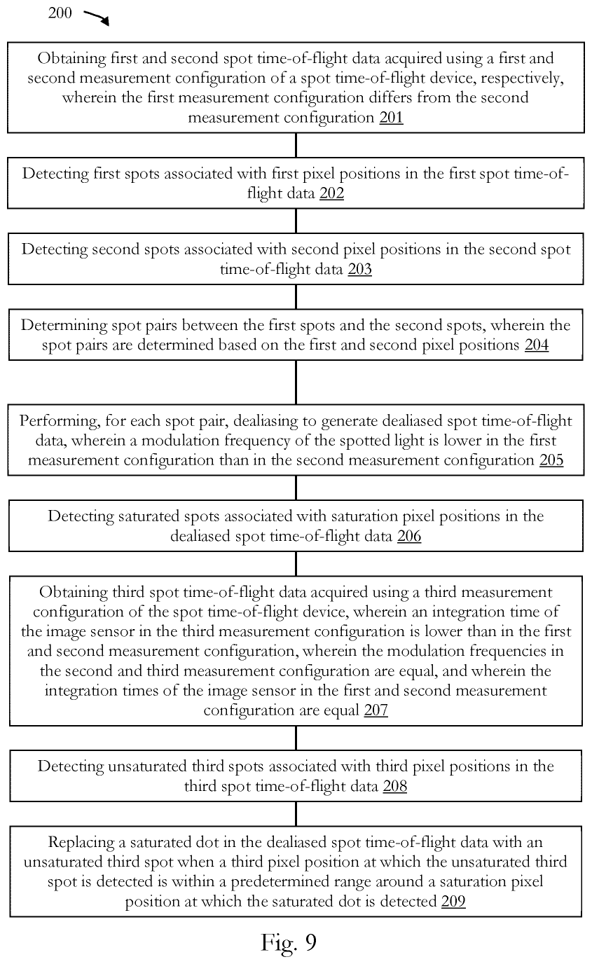

FIG. 9 schematically illustrates in a flow diagram an embodiment of an information processing method 200, which is discussed in the following.

The information processing method 200 may be performed by an information processing device as described herein.

At 201, first and second spot time-of-flight data acquired using a first and second measurement configuration of a spot time-of-flight device are obtained, respectively, wherein the first measurement configuration differs from the second measurement configuration, as discussed herein.

At 202, first spots associated with first pixel positions in the first spot time-of-flight data are detected, as discussed herein.

At 203, second spots associated with second pixel positions in the second spot time-of-flight data are detected, as discussed herein.

At 204, spot pairs between the first spots and the second spots are determined, for example, for dealiasing and/or dynamic range extension, wherein the spot pairs are determined based on the first and second pixel positions, as discussed herein.

At 205, for each spot pair, dealiasing is performed to generate dealiased spot time-of-flight data, wherein a modulation frequency of the spotted light is lower in the first measurement configuration than in the second measurement configuration, as discussed herein.

At 206, saturated spots associated with saturation pixel positions are detected in the dealiased spot time-of-flight data, as discussed herein.

At 207, third spot time-of-flight data acquired using a third measurement configuration of the spot time-of-flight device are obtained, wherein an integration time of the image sensor in the third measurement configuration is lower than in the first and second measurement configuration, wherein the modulation frequencies in the second and third measurement configuration are equal, and wherein the integration times of the image sensor in the first and second measurement configuration are equal, as discussed herein.

At 208, unsaturated third spots associated with third pixel positions are detected in the third spot time-of-flight data, as discussed herein.

At 209, a saturated dot in the dealiased spot time-of-flight data is replaced with an unsaturated third spot when a third pixel position at which the unsaturated third spot is detected is within a predetermined range around a saturation pixel position at which the saturated dot is detected, as discussed herein.

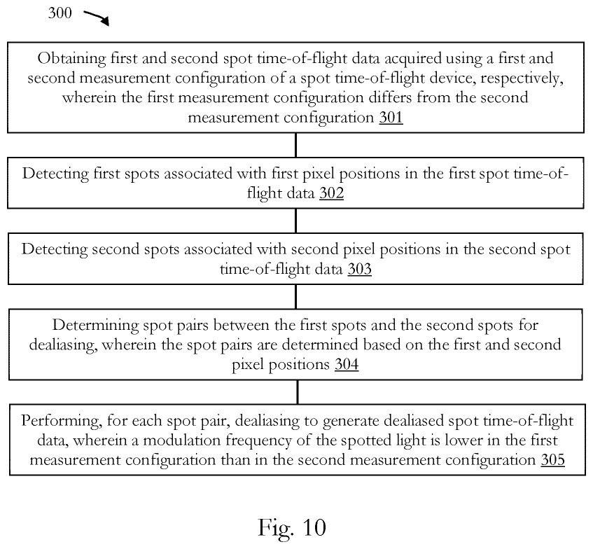

FIG. 10 schematically illustrates in a flow diagram an embodiment of an information processing method 300, which is discussed in the following.

The information processing method 300 may be performed by an information processing device as described herein.

At 301, first and second spot time-of-flight data acquired using a first and second measurement configuration of a spot time-of-flight device are obtained, respectively, wherein the first measurement configuration differs from the second measurement configuration, as discussed herein.

At 302, first spots associated with first pixel positions in the first spot time-of-flight data are detected, as discussed herein.

At 303, second spots associated with second pixel positions in the second spot time-of-flight data are detected, as discussed herein.

At 304, spot pairs between the first spots and the second spots are determined for dealiasing, wherein the spot pairs are determined based on the first and second pixel positions, as discussed herein.

At 305, for each spot pair, dealiasing is performed to generate dealiased spot time-of-flight data, wherein a modulation frequency of the spotted light is lower in the first measurement configuration than in the second measurement configuration, as discussed herein.

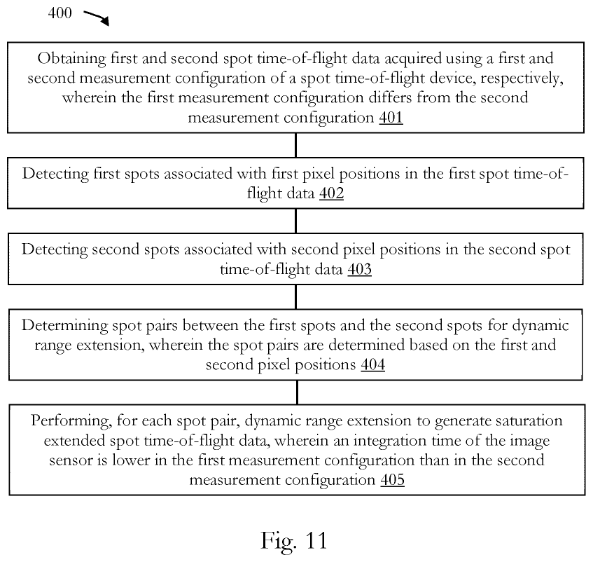

FIG. 11 schematically illustrates in a flow diagram an embodiment of an information processing method 400, which is discussed in the following.

The information processing method 400 may be performed by an information processing device as described herein.

At 401, first and second spot time-of-flight data acquired using a first and second measurement configuration of a spot time-of-flight device are obtained, respectively, wherein the first measurement configuration differs from the second measurement configuration, as discussed herein.

At 402, first spots associated with first pixel positions in the first spot time-of-flight data are detected, as discussed herein.

At 403, second spots associated with second pixel positions in the second spot time-of-flight data are detected, as discussed herein.

At 404, spot pairs between the first spots and the second spots are determined for dynamic range extension, wherein the spot pairs are determined based on the first and second pixel positions, as discussed herein.

At 405, for each spot pair, dynamic range extension is performed to generate saturation extended spot time-of-flight data, wherein an integration time of the image sensor is lower in the first measurement configuration than in the second measurement configuration, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An information processing device for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, wherein the information processing device includes circuitry configured to:
obtain first and second spot time-of-flight data acquired using a first and second measurement configuration of the spot time-of-flight device, respectively, wherein the first measurement configuration differs from the second measurement configuration;
detect first spots associated with first pixel positions in the first spot time-of-flight data;
detect second spots associated with second pixel positions in the second spot time-of-flight data; and
determine spot pairs between the first spots and the second spots, wherein the spot pairs are determined based on the first and second pixel positions.

(2) The information processing device of (1), wherein the circuitry is configured to determine a spot pair by determining whether a second pixel position at which a second spot of the second spots is detected is within a predetermined range around a first pixel position at which a first spot of the first spots is detected.

(3) The information processing device of (2), wherein the predetermined range corresponds to a pixel index window centered at the first pixel position.

(4) The information processing device of (2) or (3), wherein the circuitry is configured to assign for each spot pair, in the second spot time-of-flight data, the first pixel position to the second spot.

(5) The information processing device of anyone of (1) to (4), wherein the circuitry is configured to handle non-paired spots as invalid data.

(6) The information processing device of anyone of (1) to (5), wherein:
the first measurement configuration differs from the second measurement configuration in a modulation frequency of the spotted light, or
the first measurement configuration differs from the second measurement configuration in an integration time of the image sensor, or
the first measurement configuration differs from the second measurement configuration in an optical power of the spotted light with which the scene is illuminated.

(7) The information processing device of anyone of (1) to (5), wherein a modulation frequency of the spotted light is lower in the first measurement configuration than in the second measurement configuration, and wherein the circuitry is configured to perform, for each spot pair, dealiasing to generate dealiased spot time-of-flight data.

(8) The information processing device of (7), wherein the circuitry is configured to detect saturated spots associated with saturation pixel positions in the dealiased spot time-of-flight data.

(9) The information processing device of (8), wherein the circuitry is configured to:
obtain third spot time-of-flight data acquired using a third measurement configuration of the spot time-of-flight device, wherein an integration time of the image sensor in the third measurement configuration is lower than in the first and second measurement configuration,
detect unsaturated third spots associated with third pixel positions in the third spot time-of-flight data, and
replace a saturated dot in the dealiased spot time-of-flight data with an unsaturated third spot when a third pixel position at which the unsaturated third spot is detected is within a predetermined range around a saturation pixel position at which the saturated dot is detected.

(10) The information processing device of (9), wherein the modulation frequencies in the second and third measurement configuration are equal, and wherein the integration times of the image sensor in the first and second measurement configuration are equal.

(11) An information processing method for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, wherein the information processing method includes:
obtaining first and second spot time-of-flight data acquired using a first and second measurement configuration of the spot time-of-flight device, respectively, wherein the first measurement configuration differs from the second measurement configuration;
detecting first spots associated with first pixel positions in the first spot time-of-flight data;
detecting second spots associated with second pixel positions in the second spot time-of-flight data; and
determining spot pairs between the first spots and the second spots, wherein the spot pairs are determined based on the first and second pixel positions.

(12) The information processing method of (11), including:
determining a spot pair by determining whether a second pixel position at which a second spot of the second spots is detected is within a predetermined range around a first pixel position at which a first spot of the first spots is detected.

(13) The information processing method of (12), wherein the predetermined range corresponds to a pixel index window centered at the first pixel position.

(14) The information processing method of (12) or (13), including.
assigning for each spot pair, in the second spot time-of-flight data, the first pixel position to the second spot.

(15) The information processing method of anyone of (11) to (14), including:
handling non-paired spots as invalid data.

(16) The information processing method of anyone of (11) to (15), wherein:
the first measurement configuration differs from the second measurement configuration in a modulation frequency of the spotted light, or
the first measurement configuration differs from the second measurement configuration in an integration time of the image sensor, or
the first measurement configuration differs from the second measurement configuration in an optical power of the spotted light with which the scene is illuminated.

(17) The information processing method of anyone of (11) to (15), including:
performing, for each spot pair, dealiasing to generate dealiased spot time-of-flight data, wherein a modulation frequency of the spotted light is lower in the first measurement configuration than in the second measurement configuration.

(18) The information processing method of (17), including:
detecting saturated spots associated with saturation pixel positions in the dealiased spot time-of-flight data.

(19) The information processing method of (18), including:
obtaining third spot time-of-flight data acquired using a third measurement configuration of the spot time-of-flight device, wherein an integration time of the image sensor in the third measurement configuration is lower than in the first and second measurement configuration,
detecting unsaturated third spots associated with third pixel positions in the third spot time-of-flight data, and
replacing a saturated dot in the dealiased spot time-of-flight data with an unsaturated third spot when a third pixel position at which the unsaturated third spot is detected is within a predetermined range around a saturation pixel position at which the saturated dot is detected.

(20) The information processing method of (19), wherein the modulation frequencies in the second and third measurement configuration are equal, and wherein the integration times of the image sensor in the first and second measurement configuration are equal.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. An information processing device for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, the information processing device comprising circuitry configured to:
obtain first and second spot time-of-flight data acquired using a first and second measurement configuration of the spot time-of-flight device, respectively, wherein the first measurement configuration differs from the second measurement configuration;
detect first spots associated with first pixel positions in the first spot time-of-flight data;
detect second spots associated with second pixel positions in the second spot time-of-flight data; and
determine spot pairs between the first spots and the second spots, wherein the spot pairs are determined based on the first and second pixel positions.

2. The information processing device according to claim 1, wherein the circuitry is configured to determine a spot pair by determining whether a second pixel position at which a second spot of the second spots is detected is within a predetermined range around a first pixel position at which a first spot of the first spots is detected.

3. The information processing device according to claim 2, wherein the predetermined range corresponds to a pixel index window centered at the first pixel position.

4. The information processing device according to claim 2, wherein the circuitry is configured to assign for each spot pair, in the second spot time-of-flight data, the first pixel position to the second spot.

5. The information processing device according to claim 1, wherein the circuitry is configured to handle non-paired spots as invalid data.

6. The information processing device according to claim 1, wherein:
the first measurement configuration differs from the second measurement configuration in a modulation frequency of the spotted light, or
the first measurement configuration differs from the second measurement configuration in an integration time of the image sensor, or
the first measurement configuration differs from the second measurement configuration in an optical power of the spotted light with which the scene is illuminated.

7. The information processing device according to claim 1, wherein a modulation frequency of the spotted light is lower in the first measurement configuration than in the second measurement configuration, and wherein the circuitry is configured to perform, for each spot pair, dealiasing to generate dealiased spot time-of-flight data.

8. The information processing device according to claim 7, wherein the circuitry is configured to detect saturated spots associated with saturation pixel positions in the dealiased spot time-of-flight data.

9. The information processing device according to claim 8, wherein the circuitry is configured to:
obtain third spot time-of-flight data acquired using a third measurement configuration of the spot time-of-flight device, wherein an integration time of the image sensor in the third measurement configuration is lower than in the first and second measurement configuration,
detect unsaturated third spots associated with third pixel positions in the third spot time-of-flight data, and
replace a saturated dot in the dealiased spot time-of-flight data with an unsaturated third spot when a third pixel position at which the unsaturated third spot is detected is within a predetermined range around a saturation pixel position at which the saturated dot is detected.

10. The information processing device according to claim 9, wherein the modulation frequencies in the second and third measurement configuration are equal, and wherein the integration times of the image sensor in the first and second measurement configuration are equal.

11. An information processing method for processing spot time-of-flight data acquired by a spot time-of-flight device in a time-of-flight measurement, the spot time-of-flight device including a spot illuminator configured to illuminate a scene with spotted light and an image sensor configured to detect spotted light reflected from the scene, the information processing method comprising:
obtaining first and second spot time-of-flight data acquired using a first and second measurement configuration of the spot time-of-flight device, respectively, wherein the first measurement configuration differs from the second measurement configuration;
detecting first spots associated with first pixel positions in the first spot time-of-flight data;
detecting second spots associated with second pixel positions in the second spot time-of-flight data; and
determining spot pairs between the first spots and the second spots, wherein the spot pairs are determined based on the first and second pixel positions.

12. The information processing method according to claim 11, comprising:
determining a spot pair by determining whether a second pixel position at which a second spot of the second spots is detected is within a predetermined range around a first pixel position at which a first spot of the first spots is detected.

13. The information processing method according to claim 12, wherein the predetermined range corresponds to a pixel index window centered at the first pixel position.

14. The information processing method according to claim 12, comprising.
assigning for each spot pair, in the second spot time-of-flight data, the first pixel position to the second spot.

15. The information processing method according to claim 11, comprising:
handling non-paired spots as invalid data.

16. The information processing method according to claim 11, wherein:
the first measurement configuration differs from the second measurement configuration in a modulation frequency of the spotted light, or
the first measurement configuration differs from the second measurement configuration in an integration time of the image sensor, or
the first measurement configuration differs from the second measurement configuration in an optical power of the spotted light with which the scene is illuminated.

17. The information processing method according to claim 11, comprising:
performing, for each spot pair, dealiasing to generate dealiased spot time-of-flight data, wherein a modulation frequency of the spotted light is lower in the first measurement configuration than in the second measurement configuration.

18. The information processing method according to claim 17, comprising:
detecting saturated spots associated with saturation pixel positions in the dealiased spot time-of-flight data.

19. The information processing method according to claim 18, comprising:
obtaining third spot time-of-flight data acquired using a third measurement configuration of the spot time-of-flight device, wherein an integration time of the image sensor in the third measurement configuration is lower than in the first and second measurement configuration,
detecting unsaturated third spots associated with third pixel positions in the third spot time-of-flight data, and
replacing a saturated dot in the dealiased spot time-of-flight data with an unsaturated third spot when a third pixel position at which the unsaturated third spot is detected is within a predetermined range around a saturation pixel position at which the saturated dot is detected.

20. The information processing method according to claim 19, wherein the modulation frequencies in the second and third measurement configuration are equal, and wherein the integration times of the image sensor in the first and second measurement configuration are equal.
